(19) United States
(12) Patent Application Publication
(10) Pub. No.: US 2010/0178803 A1
(43) Pub. Date: Jul. 15, 2010

(54) Metal shell, connector and connector assembly

(75) Inventor: Ming-Yung Chang, Hsin-Tien City (TW)

Correspondence Address: BACON & THOMAS, PLLC, 625 SLATERS LANE, FOURTH FLOOR, ALEXANDRIA, VA, 22314-1176, US

(73) Assignee: Advanced Connectek Inc., Hsin-Tien City (TW)

(21) Appl. No.: 12/382,373

(22) Filed: Mar. 16, 2009

(30) Foreign Application Priority Data
Jan. 15, 2009 (TW) 098200716

(51) Int. Cl. H01R 13/648

(52) U.S. Cl. 439/607.31

(57) ABSTRACT

A connector is mounted on a printed circuit board (PCB) and has an insulative housing, a plurality of terminals and a metal shell. The PCB has a plurality of through holes. The metal shell covers the insulative housing and the terminals and has a plurality of mounting legs. The mounting legs are formed on the metal shell and each has two side edges and two solder notches defined respectively in the side edges and aligned with the through holes in the PCB. The through holes and the solder notches receive sufficient solder to securely hold the mounting legs in the through holes.

### BACKGROUND OF THE INVENTION

1. Field of the Invention

The present invention relates to a connector, and more particularly to a connector that has a metal shell having multiple mounting legs mounted on a printed circuit board (PCB). Each mounting leg has solder notches to receive solder so that the metal shell is mounted securely on the PCB.

2. Description of Related Art

A conventional connector has a metal shell and is mounted on a PCB by extending mounting legs of the metal shell respectively through the mounting holes in the PCB and attaching solder into the mounting holes to solder the metal shell on the PCB.

However, the mounting legs match the mounting holes precisely to prevent the connector from shifting on the PCB so that a gap between a mounting leg and a mounting hole is not large enough to receive sufficient solder. Furthermore, the contacting and soldering area between the metal shell and the PCB is not sufficient large. Therefore, the combination of the metal shell and the PCB is weak.

To overcome the shortcomings, the present invention provides a metal shell, a connector and a connector assembly to mitigate or obviate the aforementioned problems.

### SUMMARY OF THE INVENTION

The main objective of the invention is to provide a connector that has a metal shell having multiple mounting legs mounted on a printed circuit board (PCB). Each mounting leg has solder notches to receive solder so that the metal shell is mounted securely on the PCB.

A connector in accordance with the present invention is mounted on a printed circuit board (PCB) and comprises an insulative housing, a plurality of terminals and a metal shell. The PCB has a plurality of through holes. The metal shell covers the insulative housing and the terminals and has a plurality of mounting legs. The mounting legs are formed on the metal shell and each has two side edges and two solder notches defined respectively in the side edges and aligned with the through holes in the PCB. The through holes and the solder notches receive sufficient solder to securely hold the mounting legs in the through holes.

Other objectives, advantages and novel features of the invention will become more apparent from the following detailed description when taken in conjunction with the accompanying drawings.

### BRIEF DESCRIPTION OF THE DRAWINGS

FIG. 1 is a top perspective view of a connector in accordance with the present invention;

FIG. 2 is a bottom perspective view of the connector in FIG. 1;

FIG. 3 is an exploded perspective view of the connector in FIG. 1;

FIG. 4 is a side view in partial section of the connector in FIG. 1;

FIG. 5 is a front view in partial section of the connector in FIG. 1 mounted in a PCB; and

FIG. 6 is a side view in partial section of the connector in FIG. 5 mounted on the PCB.

### DETAILED DESCRIPTION OF THE PREFERRED EMBODIMENT

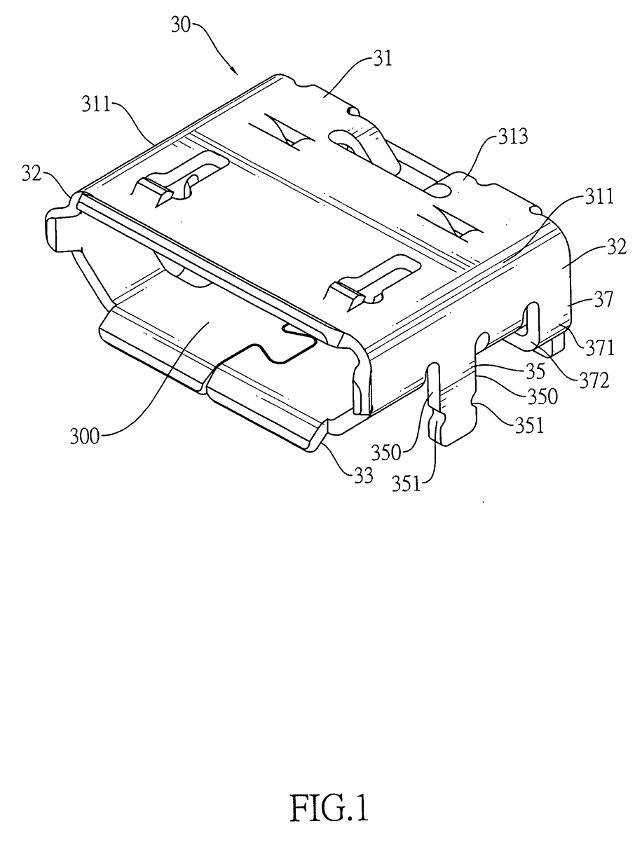

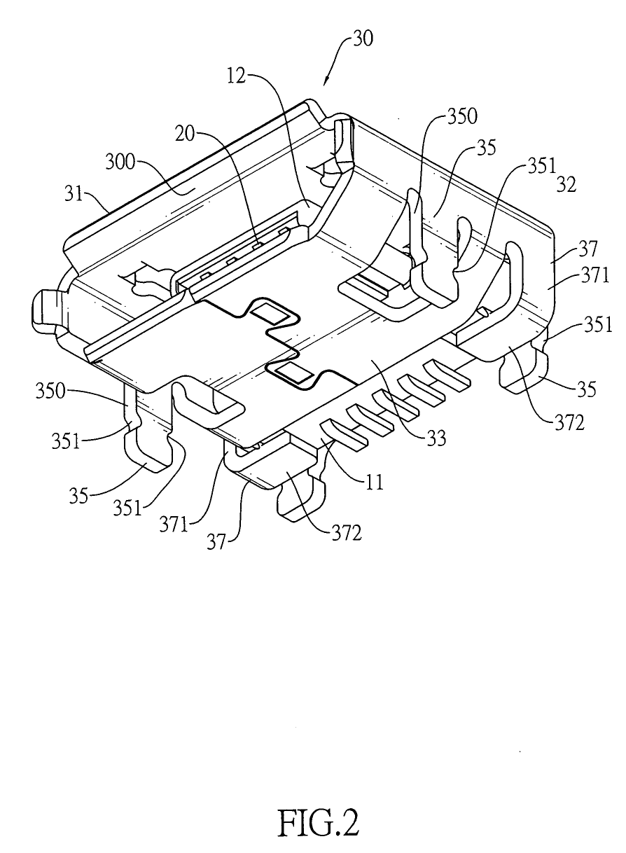

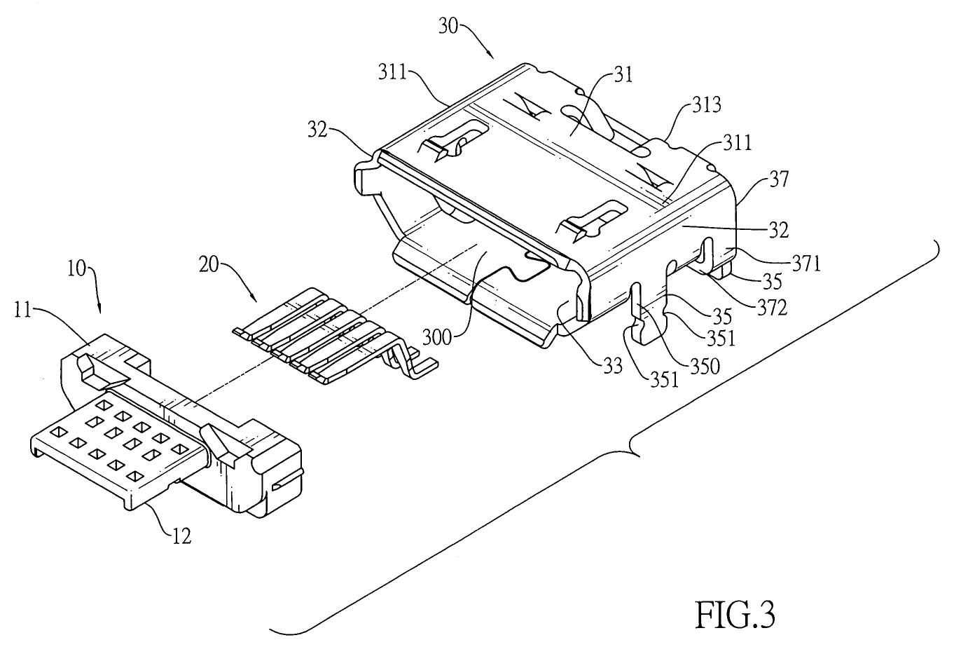

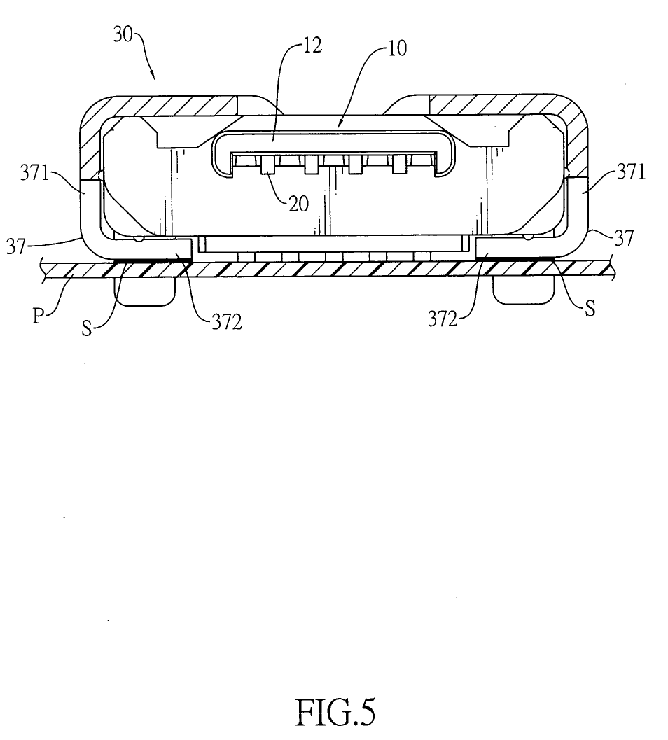

With reference to FIGS. 1 to 3 and 5, a connector assembly in accordance with the present invention comprises a connector and a printed circuit board (PCB) (P).

The connector comprises an insulative housing (10), a plurality of terminals (20) and a metal shell (30).

The insulative housing (10) has a base (11) and a tongue (12).

The base (11) has a plurality of terminal holes (111) defined in the base (11).

The tongue (12) is formed on and protrudes forwards from the base (11) and has a bottom and a plurality of terminal slots (121) defined in the bottom and communicating respectively with the terminal holes (111).

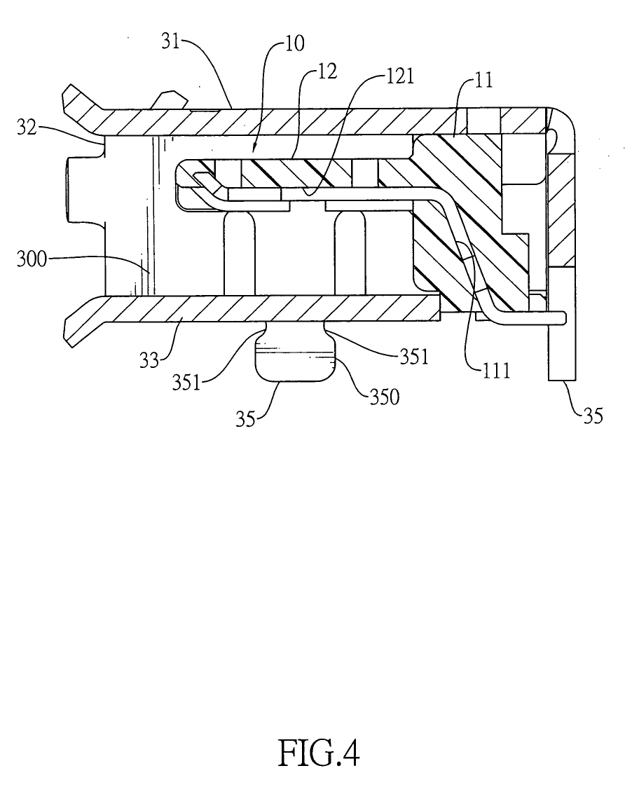

With further reference to FIG. 4, the terminals (20) are mounted respectively through the terminal holes (111) of the base (11) and are mounted respectively in the terminal slots (121) of the tongue (12).

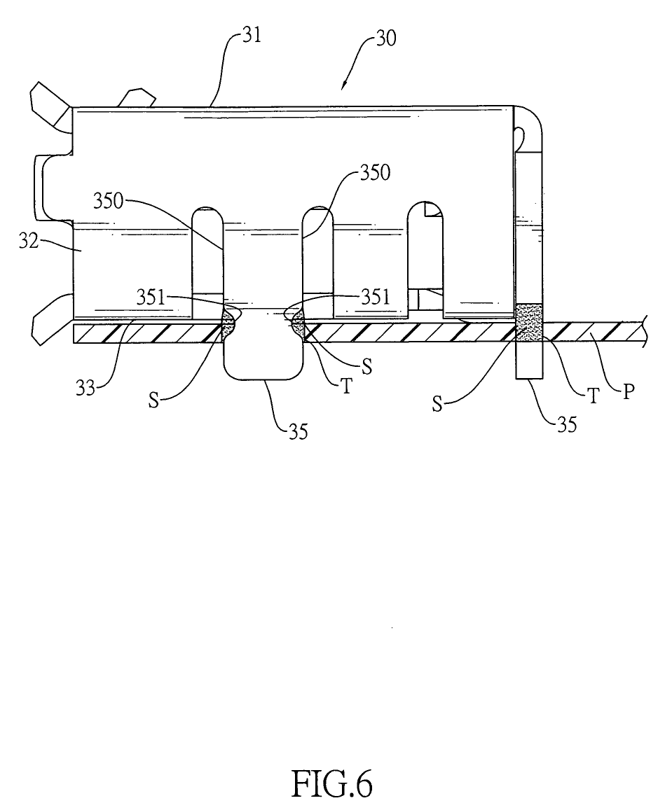

With further reference to FIG. 6, the metal shell (30) covers the insulative housing (10) and the terminals (20) and has a top plate (31), two opposite side plates (32), a bottom plate (33), an internal space (300) and a plurality of mounting legs (35) and may further have a plurality of soldering tabs (37).

The top plate (31) has two opposite edges and a rear edge (313).

The side plates (32) are formed on and protrude perpendicularly downwards respectively from the side edges of the top plate (31) and each side plate (32) has a bottom edge.

The bottom plate (33) is formed between the bottom edges of the side plates (32).

The internal space (300) is surrounded and formed by the top plate (31), the side plates (32) and the bottom plate (33) and receives the insulative housing (10) and the terminals (20).

The mounting legs (35) are formed on and protrude from downwards from the metal shell (30) and each mounting leg (35) has two opposite side edges (350) and two solder notches (351). The solder notches (351) are defined respectively in the side edges (350). In a preferred embodiment, two sets of at least one mounting leg (35) are formed respectively on the side plates (32) and one set of at least one mounting leg (35) is formed on the rear edge (313) of the top plate (31).

The soldering tabs (37) are formed on the metal shell. In a preferred embodiment, two sets of at least one soldering tab (37) correspond respectively to and are formed respectively on the side plates (32). Each soldering tab (37) is L-shaped and has an upright section (371) and a lateral soldering section (372). The upright section (371) protrudes downwards from a corresponding side plate (32). The lateral soldering section (372) is elongated, is formed on and protrudes perpendicularly inwards from the upright section (371) and is parallel to and under the bottom plate (33).

The PCB (P) is mounted under the metal shell (30) and has a top surface and a plurality of through holes (T).

The top surface of the PCB (P) is parallel to and is mounted on the lateral soldering sections (372) of the soldering tabs (37) of the metal shell (37) by attaching solder (S) between the lateral soldering sections (372) and the top surface.

The through holes (T) are defined through the PCB (P) and correspond respectively to and respectively hold the mounting legs (35) of the metal shell (35). Each through hole (T) is aligned with the solder notches (352) of a corresponding mounting leg (35) and has an inner surface so that solder notches (352) face the inner surface of the through hole (T). When the metal shell (30) is soldered on the PCB (P), the through holes (T) and the solder notches (352) are filled with solder (S) to securely hold the mounting legs (35) respectively in the through holes (T).

The connector assembly has following advantages.

1. The solder notches (352) of the mounting legs (30) is capable of receiving solder (S) so that the solder (S) in the solder notches (352) of a mounting leg (35) and the corresponding through hole (T) is sufficient to entirely surround the mounting leg (35) and completely fill the through hole (T). Therefore, the mounting leg (35) is securely held in the through hole (T)

2. The L-shaped soldering tab (37) contacts the top surface of the PCB (P) with the lateral soldering section (372) in a large contacting area so that the soldering tabs (37) are securely soldered on the PCB (P) to improve the fabricating quality and structural strength of the connector assembly.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A metal shell comprising:
a top plate having two opposite edges and a rear edge;
two opposite side plates formed on and protruding perpendicularly downwards respectively from the side edges of the top plate and each side plate having a bottom edge;
a bottom plate formed between the bottom edges of the side plates;
an internal space surrounded and formed by the top plate, the side plates and the bottom plate; and
a plurality of mounting legs formed on and protruding from downwards from the metal shell and each mounting leg having two opposite side edges and two solder notches defined respectively in the side edges.

2. The metal shell as claimed in claim 1 further comprising a plurality of soldering tabs formed on the metal shell and each soldering tab being L-shaped and having
an upright section protruding downwards from the metal shell; and
a lateral soldering section being elongated and formed on and protruding perpendicularly inwards from the upright section.

3. The metal shell as claimed in claim 2, wherein two sets of at least one mounting leg are formed respectively on the side plates and one set of at least one mounting leg is formed on the rear edge of the top plate.

4. The metal shell as claimed in claim 3, wherein the lateral soldering section of each soldering tab is parallel to and under the bottom plate.

5. The metal shell as claimed in claim 4, wherein two sets of at least one soldering tab correspond respectively to and are formed respectively on the side plates and the upright section of each soldering tab protrudes downwards from a corresponding side plate.

6. A connector comprising:
an insulative housing having
a base; and
a tongue formed on and protruding forwards from the base;
a plurality of terminals mounted through the base and mounted in the tongue; and
a metal shell covering the insulative housing and the terminals and having
a top plate having two opposite edges and a rear edge;
two opposite side plates formed on and protruding perpendicularly downwards respectively from the side edges of the top plate and each side plate having a bottom edge;
a bottom plate formed between the bottom edges of the side plates;
an internal space surrounded and formed by the top plate, the side plates and the bottom plate; and
a plurality of mounting legs formed on and protruding from downwards from the metal shell and each mounting leg having two opposite side edges and two solder notches defined respectively in the side edges.

7. The connector as claimed in claim 6, wherein
the base has a plurality of terminal holes defined through the base;
the tongue has a bottom and a plurality of terminal slots defined in the bottom and communicating respectively with the terminal holes; and
the terminals are mounted respectively through the terminal holes and are mounted respectively in the terminal slots.

8. A connector assembly comprising
a connector having
an insulative housing having
a base; and
a tongue formed on and protruding forwards from the base;
a plurality of terminals mounted through the base and mounted in the tongue; and
a metal shell covering the insulative housing and the terminals and having
a top plate having two opposite edges and a rear edge;
two opposite side plates formed on and protruding perpendicularly downwards respectively from the side edges of the top plate and each side plate having a bottom edge;
a bottom plate formed between the bottom edges of the side plates;
an internal space surrounded and formed by the top plate, the side plates and the bottom plate; and
a plurality of mounting legs formed on and protruding from downwards from the metal shell and each mounting leg having two opposite side edges and two solder notches defined respectively in the side edges; and
a printed circuit board (PCB) mounted under the metal shell and having
a top surface; and
a plurality of through holes defined through the PCB and corresponding respectively to and respectively holding the mounting legs of the metal shell, wherein the solder notches and the through holes are filled with solder.

9. The connector assembly as claimed in claim 8, wherein each through hole is aligned with the solder notches of a corresponding mounting leg and has an inner surface, and the solder notches of the corresponding mounting leg face the inner surface of the through hole.

10. The connector assembly as claimed in claim 9, wherein
the metal shell further has a plurality of soldering tabs formed on the metal shell and each soldering tab being L-shaped and having
an upright section protruding downwards from the metal shell; and
a lateral soldering section being elongated, formed on and protruding perpendicularly inwards from the upright section and being parallel to and mounted on the top surface of the PCB by attaching solder between the lateral soldering section and the top surface.
